(19) United States
(12) Patent Application Publication
(10) Pub. No.: US 2007/0250517 A1
(43) Pub. Date: Oct. 25, 2007

(54) Method and Apparatus for Autonomically Maintaining Latent Auxiliary Database Structures for Use in Executing Database Queries

(76) Inventors: Robert Joseph Bestgen, Rochester, MN (US); Curtis Neal Boger, Oronoco, MN (US); David Glenn Carlson, Rochester, MN (US); Robert Victor Downer, Rochester, MN (US); Steven Virgil Hoeschen, Rochester, MN (US); Kevin James Kathmann, Rochester, MN (US); Shantan Kethireddy, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/379,503

(22) Filed: Apr. 20, 2006

(51) Int. Cl. G06F 7/00

(52) U.S. Cl. 707/100

(57) ABSTRACT

A latent auxiliary database structure constructed for executing a query is automatically saved for reuse in subsequent query execution instances. The latent auxiliary database structure is not maintained concurrently with changes to records in the database tables. If a query execution strategy is subsequently invoked which uses the latent auxiliary database structure, a determination is made dynamically whether to update the previously saved latent structure from database changes recorded in one or more change logs, or to rebuild the latent structure from scratch. Where the cost of updating from the change log is deemed less than the cost of a rebuild from scratch, the previously saved latent structure is updated from the log.

### FIELD OF THE INVENTION

The present invention relates generally to digital data processing, and more particularly to the generation and execution of database queries in a digital computer system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises hardware in the form of one or more central processing units (CPU) for processing instructions, memory for storing instructions and other data, and other supporting hardware necessary to transfer information, communicate with the external world, and so forth. From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster. Therefore continuing improvements to computer systems require that these systems be made ever faster.

The overall speed at which a computer system performs day-to-day tasks (also called “throughput”) can be increased by making various improvements to the computer's hardware design, which in one way or another increase the average number of simple operations performed per unit of time. The overall speed of the system can also be increased by making algorithmic improvements to the system design, and particularly, to the design of software executing on the system. Unlike most hardware improvements, many algorithmic improvements to software increase the throughput not by increasing the average number of operations executed per unit time, but by reducing the total number of operations which must be executed to perform a given task.

Complex systems may be used to support a variety of applications, but one common use is the maintenance of large databases, from which information may be obtained. Large databases usually support some form of database query for obtaining information which is extracted from selected database fields and records. Such queries can consume significant system resources, particularly processor resources, and the speed at which queries are performed can have a substantial influence on the overall system throughput.

Conceptually, a database may be viewed as one or more tables of information, each table having a large number of entries (analogous to rows of a table), each entry having multiple respective data fields (analogous to columns of the table). The function of a database query is to find all rows, for which the data in the columns of the row matches some set of parameters defined by the query. A query may be as simple as matching a single column field to a specified value, but is often far more complex, involving multiple field values and logical conditions. A query may also involve multiple tables (referred to as a “join” query), in which the query finds all sets of N rows, one row from each respective one of N tables joined by the query, where the data from the columns of the N rows matches some set of query parameters.

Execution of a query involves retrieving and examining records in the database according to some search strategy. For any given logical query, not all search strategies are equal. Various factors may affect the choice of optimum search strategy and the time or resources required to execute the strategy.

For example, one of the factors affecting query execution is the sequential order in which multiple conditions joined by a logical operator, such as AND or OR, are evaluated. The sequential order of evaluation is significant because the first evaluated condition is evaluated with respect to all the entries in a database table, but a later evaluated condition need only be evaluated with respect to some subset of records which were not eliminated from the determination earlier. Therefore, as a general rule, it is desirable to evaluate those conditions which are most selective first. Another factor can be the presence of certain auxiliary database structures which may, if appropriately used, provide shortcuts for evaluating a query. One well known type of auxiliary database structure is an index. An index is conceptually a sorting of entries in a database table according to the value of one or more corresponding fields (columns). If a query includes an indexed value as a condition, it may be advantageous to use the index to determine responsive records, rather than examine each record in the applicable table. Query execution may be affected by any number of factors in addition to those described above.

Auxiliary database structures, such as indexes, are typically defined by a database designer, administrator or similar person. A well-designed database typically contains various auxiliary database structures to support query execution or for other purposes. Once defined, these structures are automatically maintained by database management software as changes are made to the underlying database records.

To support database queries, large databases typically include a query engine which executes the queries according to some automatically selected search (execution) strategy, using the known characteristics of the database and other factors. Some large database applications further have query optimizers which construct search strategies, and save the query and its corresponding search strategy for reuse. In such systems, it may be possible to construct and save multiple different query execution strategies for a single query.

Where an auxiliary database structure, such as an index, exists and is useful in executing a query, a query optimizer may construct an execution strategy to take advantage of the existing auxiliary database structure as a shortcut to executing the query. However, in many complex queries, it is desirable or essential to employ some auxiliary database structure in executing the query, but no such defined auxiliary database structure already exists. In these cases, the query optimizer may generate an execution strategy which itself constructs the needed auxiliary database structure in executing the query. An internally constructed auxiliary database structure which is not defined in the database specification, and is therefore generally hidden from users, is referred to herein as a “latent auxiliary database structure”. Conventionally, such latent auxiliary database structures are only for temporary use in executing a single instance of a query. Because the latent auxiliary database structure is not defined in the database specification, and is not maintained by database management software, it is generally deleted after the database query executes.

A query execution strategy which constructs a latent auxiliary database structure for temporary use may itself be saved and reused many times to execute different instances of the same query. Conventionally, such a query execution strategy will reconstruct the latent auxiliary database structure from scratch each time it executes. Although not necessarily recognized in the art, an improvement in execution performance could be obtained if, in selective circumstances, such a latent auxiliary database structure could be saved and reused when another instance of the same query executes. Furthermore, although not necessarily recognized in the art, an additional improvement in execution performance could be obtained if, in appropriate circumstances, such a latent auxiliary database structure could be made available for use in executing queries other than the one for which it was originally constructed.

### SUMMARY OF THE INVENTION

A latent auxiliary database structure constructed for executing a query is automatically saved for reuse in subsequent execution instances of the same and/or a different query. In general, the latent auxiliary database structure is not maintained concurrently with changes to records in the database tables. If a query execution strategy is subsequently invoked which uses the latent auxiliary database structure, a determination is made dynamically whether to update the previously saved database structure from database changes recorded in one or more change logs, or to rebuild the latent auxiliary database structure from scratch. Where the cost of updating from the change log is deemed less than the cost of a rebuild from scratch, the previously saved latent auxiliary database structure is updated from the log.

In the preferred embodiment, a latent auxiliary database structure can be used by any query execution strategy, and is not limited to use by the strategy which originally generated it. In an alternative embodiment, a latent auxiliary database structure might be used only by the strategy which created it.

In the preferred embodiment, each saved latent auxiliary database structure is associated with one or more query execution strategies which use it. These execution strategies may be different strategies for the same query, or strategies for different queries. Execution strategies are deleted from time to time as new execution strategies and/or queries are constructed, changes are made to the database, etc. When a latent auxiliary database structure is no longer associated with any query execution strategies as a result of such changes, it is automatically deleted.

By saving latent auxiliary database structures without concurrent maintenance in accordance with the preferred embodiment, negligible additional administrative burden is placed on database management software. However, the latent auxiliary structure is available should it be needed. It will only be updated (from the change log), where the cost of doing so is less than that of rebuilding from scratch (as in conventional art),and therefore will only be updated in those cases where an actual cost saving is projected.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for executing database queries and autonomically maintaining latent auxiliary database structures, according to the preferred embodiment of the present invention.

FIG. 2 is a conceptual illustration of the major software components of a computer system for executing database queries and autonomically maintaining latent auxiliary database structures, according to the preferred embodiment.

FIG. 3 is a conceptual representation of a persistent query object of a plan cache, according to the preferred embodiment.

FIG. 4 is a conceptual representation of the structure of representative latent auxiliary database structures, according to the preferred embodiment.

FIG. 5 is a flow diagram illustrating at a high level the process of executing a database query, according to the preferred embodiment.

FIG. 6 is a flow diagram showing the in greater detail the process of generating and saving an execution strategy, according to the preferred embodiment.

FIG. 7 is a flow diagram showing the in greater detail the process of executing a query according to a generated or selected execution strategy, according to the preferred embodiment.

### DETAILED DESCRIPTION OF THE PREFERRED EMBODIMENTS

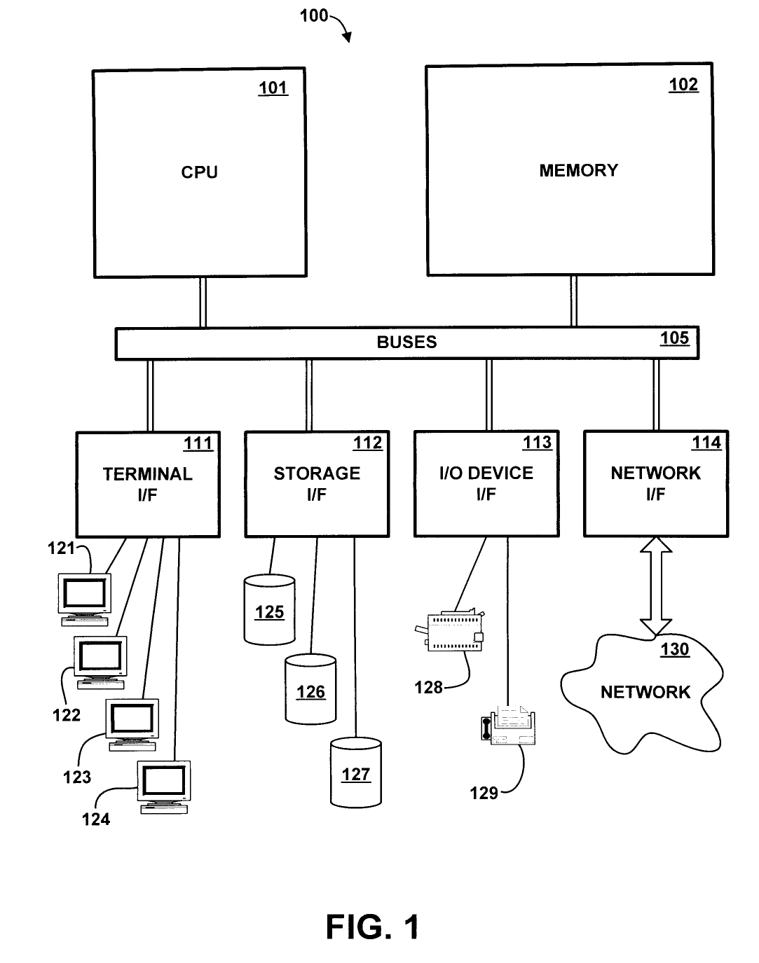

Referring to the Drawing, wherein like numbers denote like parts throughout the several views, FIG. 1 is a high-level representation of the major hardware components of a computer system 100 for use in generating and executing database queries, creating and saving latent auxiliary database structures, and updating the latent auxiliary database structures for later reuse where appropriate, according to the preferred embodiment of the present invention. CPU 101 is at least one general-purpose programmable processor which executes instructions and processes data from main memory 102. Main memory 102 is preferably a random access memory using any of various memory technologies, in which data is loaded from storage or otherwise for processing by CPU 101.

One or more communications buses 105 provide a data communication path for transferring data among CPU 101, main memory 102 and various I/O interface units 111-114, which may also be known as I/O processors (IOPs) or I/O adapters (IOAs). The I/O interface units support communication with a variety of storage and 1/0 devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O device interface unit 113 supports the attachment of any of various other types of I/O devices, such as printer 128 and fax machine 129, it being understood that other or additional types of I/O devices could be used. Network interface 114 supports a connection to an external network 130 for communication with one or more other digital devices. Network 130 may be any of various local or wide area networks known in the art. For example, network 130 may be an Ethernet local area network, or it may be the Internet. Additionally, network interface 114 might support connection to multiple networks.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary, and that a large computer system will typically have more components than represented in FIG. 1. Several particular examples of such additional complexity or additional variations are disclosed herein, it being understood that these are by way of example only and are not necessarily the only such variations.

Although only a single CPU 101 is shown for illustrative purposes in FIG. 1, computer system 100 may contain multiple CPUs, as is known in the art. Although main memory 102 is shown in FIG. 1 as a single monolithic entity, memory 102 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 105 are shown in FIG. 1 as a single entity, in fact communications among various system components is typically accomplished through a complex hierarchy of buses, interfaces, and so forth, in which higher-speed paths are used for communications between CPU 101 and memory 102, and lower speed paths are used for communications with I/O interface units 111-114. Buses 105 may be arranged in any of various forms, such as point-to-point links in hierarchical, star or web configurations, multiple hierarchical buses, parallel and redundant paths, etc. For example, as is known in a NUMA architecture, communications paths are arranged on a nodal basis. Buses may use, e.g., an industry standard PCI bus, or any other appropriate bus technology. While multiple I/O interface units are shown which separate buses 105 from various communications paths running to the various I/O devices, it would alternatively be possible to connect some or all of the I/O devices directly to one or more system buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. User workstations or terminals which access computer system 100 might also be attached to and communicate with system 100 over network 130. Computer system 100 may alternatively be a single-user system, typically containing only a single user display and keyboard input. Furthermore, while the invention herein is described for illustrative purposes as embodied in a single computer system, the present invention could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 100 is a computer system based on the IBM i/Series™ architecture, it being understood that the present invention could be implemented on other computer systems.

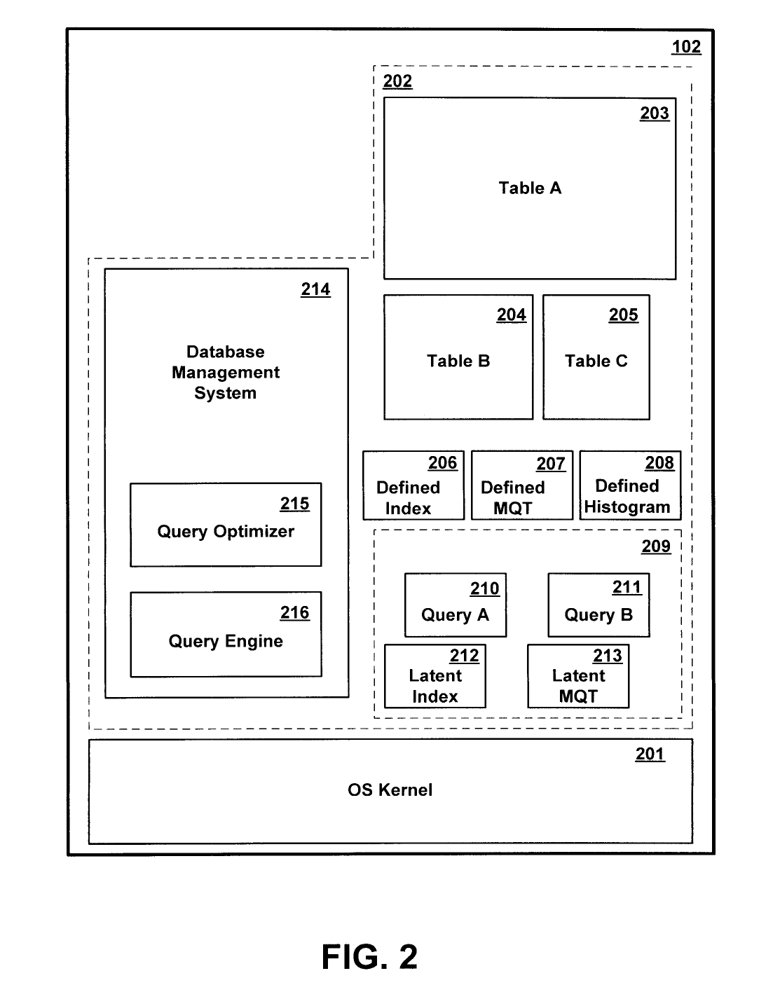

FIG. 2 is a conceptual illustration of the major software components of system 100 in memory 102. Operating system kernel 201 is executable code and state data providing various low-level software functions, such as device interfaces, management of memory pages, management and dispatching of multiple tasks, etc. as is well-known in the art. A structured database 202 contains data which is maintained by computer system 100 and for which the system provides access to one or more users, who may be directly attached to system 100 or may be remote clients who access system 100 through a network using a client/server access protocol.

Database 202 contains one or more tables 203-205 (of which three are shown in FIG. 2), each having a plurality of entries or records, each entry containing at least one (and usually many) fields, as is well known in the art. Database tables 203-205 might contain almost any type of data which is provided to users by a computer system. Associated with the database tables are one or more auxiliary data structures 206-213, also sometimes referred to as metadata. Auxiliary data structures characterize the structure of the database and data therein, and are useful in various tasks involved in database management, particularly in executing queries against the database. Examples of auxiliary data structures include defined database index 206, defined materialized query table 207, defined histogram 208, and plan cache 209, containing saved query objects 210-211, latent database index 212 and latent materialized query table 213, it being understood that other types of metadata may exist.

Database management system 214 provides basic functions for the management of database 202. Database management system 214 may theoretically support an arbitrary number of database tables, which may or may not have related information, although only three tables are shown in FIG. 2. Database management system 214 preferably allows users to perform basic database operations, such as defining a database, altering the definition of the database, creating, editing and removing records in the database, viewing records in the database, defining database auxiliary data structures such as indexes and materialized query tables, and so forth. Among the functions supported by database management system 214 is the making of queries against data in database tables 203-205. Query support functions in database management system 211 include query optimizer 215 and query engine 216. Database management system 214 may further contain any of various more advanced database functions. Although database management system 214 is represented in FIG. 2 as an entity separate from operating system kernel 201, it will be understood that in some computer architectures various database management functions are integrated with the operating system.

Query optimizer 215 generates query execution strategies for performing database queries. As is known in the database art, the amount of time or resource required to perform a complex query on a large database can vary greatly, depending on various factors, such as the availability of an index or other auxiliary data structure, the amount of resources required to evaluate each condition, and the expected selectivity (i.e., number of records eliminated from consideration) of the various logical conditions. Optimizer 212 determines an optimal execution strategy according to any optimizing algorithm, now known or hereafter developed, and generates an execution strategy, also known as an “access plan” or “plan”, according to the determination. The execution strategy is a defined series of steps for performing the query, and thus is, in effect, a computer program. The optimizer 215 which generates the execution strategy performs a function analogous to that of a compiler, although the execution strategy data is not necessarily executable-level code. It is, rather, a higher-level series of statements which are interpreted and executed by query engine 216.

A query can be saved as a persistent storage object in memory, and can be written to disk or other storage. Once created by optimizer 212, a query execution strategy can be saved with the query as part of the persistent storage object. The query can be invoked, and a saved query strategy re-used (re-executed), many times. For a given query, it is possible to generate and save one, or optionally multiple, query execution strategies, each optimized for different respective conditions. E.g., where a query contains an imported (“host”) variable in one of its conditions, the value of which is specified at the time the query is executed, different query execution strategies could be used for different values of the imported variable. Different query execution strategies might also be used for different environmental parameters under which the query is to be executed. In addition to saving one or more query execution strategies, certain metadata with respect to each query execution strategy can be saved, such as the conditions for which the strategy was generated and historical data concerning the execution of the strategy.

A defined structure such as defined index 206, defined materialized query table 207 or defined histogram 208 is an auxiliary database structure which is specified by a database designer, administrator, or similar person as part of the database definition, i.e. a data structure which is part of the database and is available for use by users accessing the database. Database management system 214 automatically maintains such defined auxiliary database structures concurrently with changes made to records in database tables 203-205. A query execution strategy will often use a defined auxiliary database structure such as index 206 or MQT 207 to execute a query. In some cases, it is necessary or desirable to use such a structure where no defined structure exists. In these cases, the query execution strategy may build a latent auxiliary data structure as an intermediate step in executing the query. Latent index object 212 and latent MQT are two examples of latent auxiliary database structures, it being understood that a latent auxiliary database structure could include other types of objects constructed to execute a query where no suitable defined structure exists, such as a hash table, a sorted list, a simple copy of intermediate query results, or a bitmap of records or record references the corresponds to potentially selected records from a set of selection. Conventionally, latent structures are typically deleted after the query executes. In the preferred embodiment, these latent structures are saved as persistent objects for possible later reuse. Except when being actively used for a query, these latent structures are not concurrently maintained as changes are made to the database table or tables.

The collection of saved queries, query execution strategies, saved latent indexes, MQT's and so forth, and associated data, is loosely referred to as the “plan cache”. FIG. 2 represents plan cache 209, containing persistent storage objects Query A 210 and Query B 211, persistent storage object latent index 212, and persistent storage object latent MQT 213. Although two query objects, one latent index object, and one latent MQT object are represented for illustrative purposes in FIG. 2, it will be understood that the actual number of such entities may vary, that typically a large computer system contains a much larger number of query objects and latent objects, that each query object may contain or be associated with zero, one, or more than one execution strategies. Although these are referred to herein as “query objects”, “latent index objects” or “latent MQT objects”, the use of the term “object” is not meant to imply that database management system 214 or other components are necessarily programmed using so-called object-oriented programming techniques, or that the query object or latent object necessarily has the attributes of an object in an object-oriented programming environment, although it would be possible to implement them using object-oriented programming constructs.

Although one database 202 having three database tables 203-205, one defined index 206, one defined MQT 207 and one defined histogram 208 are shown in FIG. 2, the number of such entities may vary, and could be much larger. The computer system may contain multiple databases, each database may contain multiple tables, and each database may have associated with it multiple indexes, MQTs, histograms, or other auxiliary data structures not illustrated. Alternatively, some entities represented in FIG. 2 might not be present in all databases; for example, some databases might not contain materialized query tables or the like. Additionally, database 202 may be logically part of a larger distributed database which is stored on multiple computer systems. Although database management system 214 is represented in FIG. 2 as part of database 202, the database management system, being executable code, is sometimes considered an entity separate from the “database”, i.e., the data.

In addition to database management system 214, one or more user applications (not shown) may access data in database tables 203-205 to perform tasks on behalf of one or more users, and may use defined auxiliary database structures to do so. Such user applications may execute on computer system 100, or may access the database from remote systems. Such user applications may include, e.g., personnel records, accounting, code development and compilation, mail, calendaring, or any of thousands of user applications.

Various software entities are represented in FIG. 2 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representation of FIG. 2, it will be understood that the actual number of such entities may vary, and in particular, that in a complex database server environment, the number and complexity of such entities is typically much larger. Additionally, although software components 202-216 are depicted in FIG. 2 on a single computer system 100 for completeness of the representation, it is not necessarily true that all programs, functions and data will be present on a single computer system or will be performed on a single computer system.

While the software components of FIG. 2 are shown conceptually as residing in memory 102, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. In particular, database tables 203-205 are typically much too large to be loaded into memory, and typically only a small portion of the total number of database records is loaded into memory at any one time. The full database 202 is typically recorded in disk storage 125-127. Furthermore, it will be understood that the conceptual representation of FIG. 2 is not meant to imply any particular memory organizational model, and that system 100 might employ a single address space virtual memory, or might employ multiple virtual address spaces which overlap.

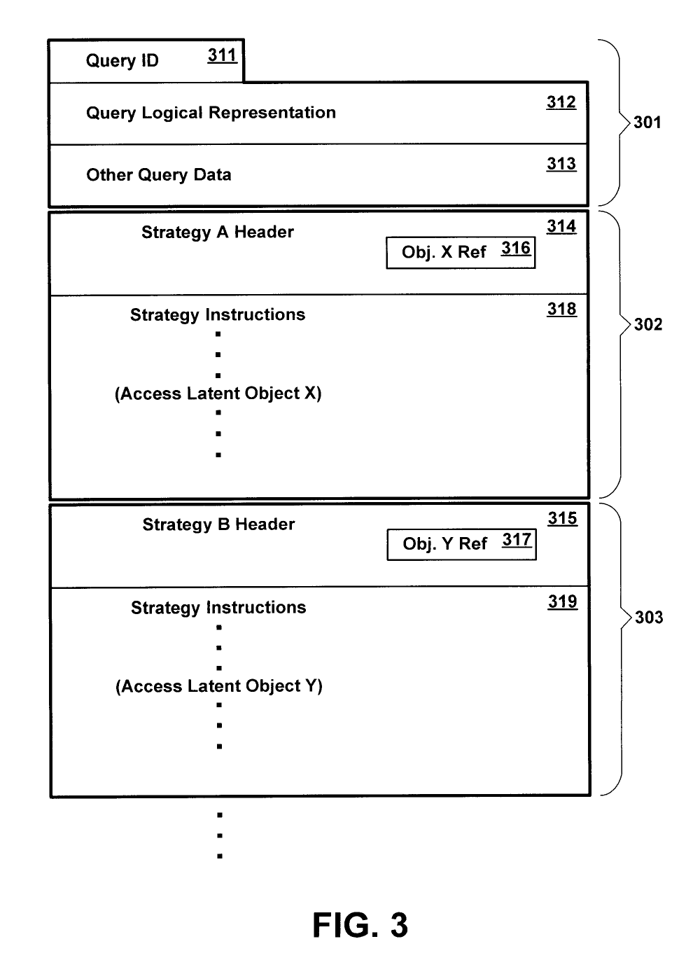

FIG. 3 is a conceptual representation of a typical persistent query object 210, 211 of plan cache 209, according to the preferred embodiment. A query object contains a header portion 301, and a variable number of execution strategy blocks 302, 303 (of which two are represented in the example of FIG. 3 for clarity, it being understood that a larger number could be, and often are, present). The header portion contains a query identifier field 311, a query logical representation 312, and optional additional query data 313. The query logical representation 312 is a representation of the query in a form understandable by the query optimizer 215 and/or query engine 216, from which a query execution strategy can be constructed. Additional query data 313 includes various other data which might be useful to database management system 214 or other applications accessing a query. For example, additional data 314 might include a text description of the query, security and access control information, historical statistics regarding query execution performance, and so forth. Additional query data 313 is represented in FIG. 3 as a single block of data for clarity of illustration; however, such additional data will typically comprise multiple fields, some of which may be optional or of variable length, or may reference data in other data structures.

Each execution strategy block 302, 303 contains data relating to a particular execution strategy for the query. As is known in the art of database management, the choice of an optimal query execution strategy could depend in numerous factors, including the resources allocated to a particular user or process invoking a query, the values of imported variables within the query, the state of the system, and so forth. Query optimizer 216 can generate, and database manager 214 can save, multiple query execution strategies for a given query, each appropriate for use under a different respective set of conditions. Each execution strategy block 302 corresponds to a respective execution strategy for the query.

In general, an execution strategy block 302, 303 contains a strategy header portion 314, 315 comprising various data for use by the data management system in selecting or maintaining the strategies. For example, a strategy header may contain host variable, environmental parameter or other execution conditions governing use of the corresponding strategy to enable the data management system to determine whether the strategy should be selected for executing a particular instance of the query; historical performance statistics of the corresponding strategy; and other data. Among the data included in the strategy header is a reference 316, 317 to any latent objects 212, 213 which are accessed by the corresponding strategy during execution. A single strategy could reference zero, one or multiple latent objects.

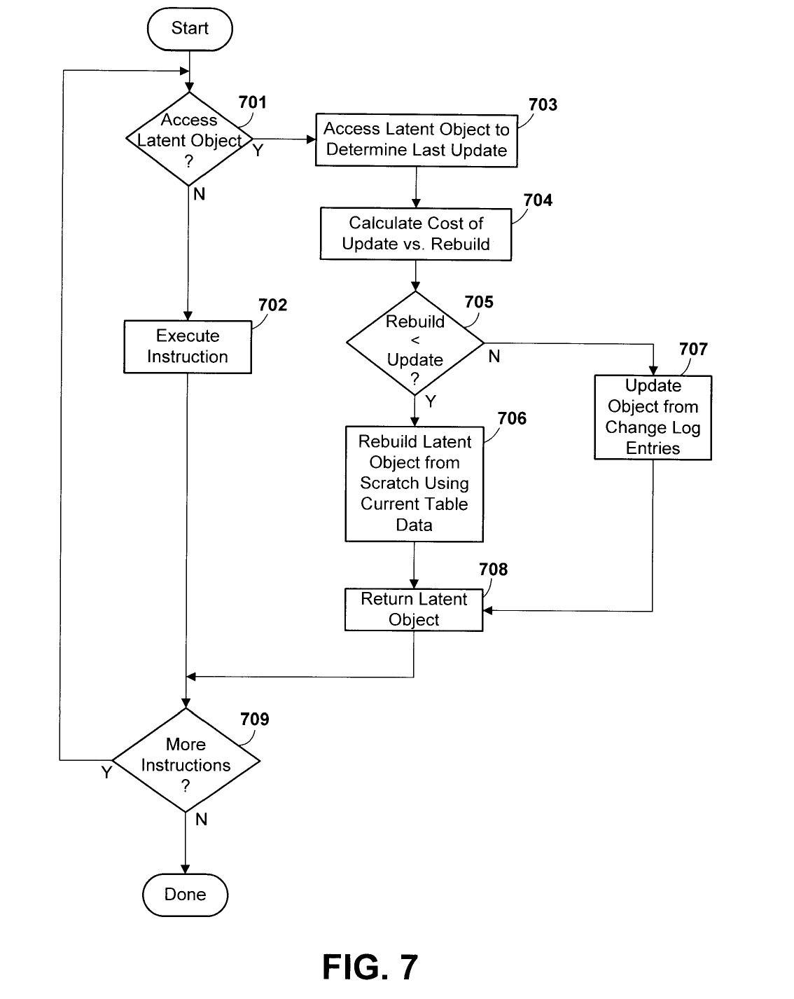

Each strategy block 302, 303 further contains a respective set of strategy instructions 318, 319 for executing the corresponding strategy. In the preferred embodiment, these are not directly executable code, but are higher-level instructions which are interpreted by the query engine 216 to execute the query. These instructions determine the order of searching certain tables, whether or not indexes or other auxiliary data structures are used to search the database records, and so on. In particular, these instructions may access latent objects 212, 213 in order to execute the query. The referencing of latent objects during execution is described in greater detail below with respect to FIG. 7.

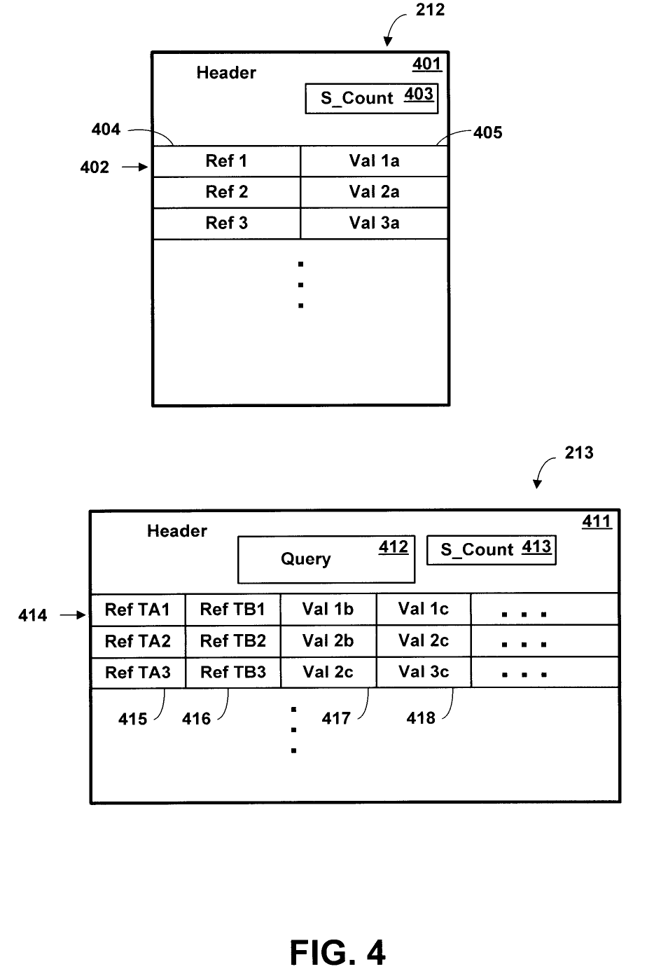

FIG. 4 is a conceptual representation of the structure of a representative latent index object 212 and representative latent materialized query table object 213, according to the preferred embodiment. Index 212 and materialized query table 213 are derivations of information in one or more database tables 203-205. As is well known in the are, each database table 203-205 contains multiple database entries (also called records, or rows), each entry containing multiple data values logically organized as multiple data fields. A database table is conceptually a table or array, in which the rows represent database entries, and the columns represent data fields. However, as is well known in the art, the actual structure of the database in memory typically varies due to the needs of memory organization, accommodating database updates, and so forth. A database table will often occupy non-contiguous blocks of memory; database records may vary in length; some fields might be present in only a subset of the database records; and individual entries may be non-contiguous. Portions of the data may even be present on other computer systems.

A database index object 212 corresponds to a particular database table, and provides a sorted ordering of the records in that database table according to some logical criterion. Typically, an index sorts the database according to the value of a specific field, and where there are multiple occurrences of the same value, may use one or more additional fields to sort among those multiple values. However, an index could use some other sorting criterion, such as a mathematical function of multiple field values. A database may have many indexes, each being used to sort the database records according to some different criterion, such as different field values.

Each index object contains a header 401 and a plurality of entries 402, each entry 402 corresponding to a respective entry or row of a database table to which the index corresponds. Header 401 contains information useful for using and maintaining the index object, such as an identification of the table to which it corresponds, object boundaries, and so forth. In particular, in the case of latent index objects 212, header 401 contains a strategy count 403. Strategy count 403 is an integer recording the number of query strategies which access the latent index object, and is used for maintenance purposes to delete objects no longer needed, as explained further herein. Each entry 402 contains a respective reference 404 and one or more values 405 (of which one is shown in FIG. 4). The reference 404 is a reference to the corresponding entry in the database table. A reference could be a pointer, array index, record number, etc., which enables one to identify and access the corresponding database table entry. The value 405 is a value used to sort the index, such as the value from a field of the corresponding database entry. E.g., for index 203, which sorts database records according to the value of field ‘a’, the value 405 is the value of field ‘a’ for each corresponding database record. Where multiple fields of the database table are used as a logical sorting criterion to sort the index, there could be multiple value fields 405 in each index entry 402. Although indexes object 212 is represented conceptually in FIG. 4 as containing a table or array of index entries and fields, a different structure, such as a binary tree, is typically used due to the need to update the indexes responsive to database updates, and to quickly identify the location of a desired value in the sorted order.

A materialized query table (MQT) object 213 is conceptually a table representing the results of a hypothetical defining query. The defining query could be a query against information in a single database table, or could be a join of information in multiple database tables. The hypothetical defining query is often a sub-part of multiple more complex queries, which may use the materialized query table for execution.

A representative materialized query table object 213 shown in FIG. 4 contains a header 411 and multiple MQT entries 414, each entry corresponding to a respective set of data satisfying the results of the hypothetical defining query. The header contains information useful for using or maintaining the MQT, and in particular contains (or references) the hypothetical defining query 412 and a strategy count 413. Strategy count 413 is an integer recording the number of query strategies which access the MQT object, and is used for maintenance purposes to delete objects no longer needed, as explained further herein.

Each entry or row 402 of MQT object 213 contains a one or more respective references 415, 416 and values 417, 418, the number of each depending on the defining query. In the simple case where the defining query operates on a single database table 203, each row of the MQT represents an entry from that single database table which satisfies the conditions of the defining logical query. In the case of a defining query which joins a set of multiple database tables, each row of the MQT represents a set of entries from each of the set of multiple database tables joined by the query, the set of entries satisfying the conditions of the defining query. FIG. 4. represents an MQT in which the defining query is a logical join of two database tables Table A and Table B. Each reference 415, 416 is a reference to a corresponding entry in a database table which is included in the defining query. For example, in FIG. 4, reference 415 contains a reference to a corresponding entry in Table A, and reference 416 contains a reference to a corresponding entry in Table B, the pair of referenced entries in Table A and Table B satisfying the conditions of the defining join query. A reference could be a pointer, array index, record number, etc., which enables one to identify and access the corresponding database table entry. Each entry 402 preferably further contains values 417, 418 from selective fields of Table A and/or Table B, which could be all the fields of these two tables, but is generally fewer than all fields of the two tables. The entries 402 within the MQT could alternatively contain only references 415, 416 to corresponding entries in the tables, without containing any field values 417, 418, or could contains the field values 417, 418 without references 415, 416.

Among the functions supported by database management system 214 is the making of queries against data in database 202, which are executed by query engine 216. As is known, queries typically take the form of statements having a defined format, which test records in the database to find matches to some set of logical conditions. Typically, multiple terms, each expressing a logical condition, are connected by logical conjunctives such as “AND” and “OR”. Many queries use existing defined auxiliary database structure such as indexes, materialized query tables and the like to reduce the scope of execution activity. Because database 202 may be very large, having a very large number of records, and a query may be quite complex, involving multiple logical conditions, a suitable index or similar structure does not always exist for a given need. It is often helpful to generate some index or other auxiliary database structure, which is not defined in the database, solely for the purpose of executing the query. In conventional systems, such structures are typically used once and deleted after use.

In accordance with the preferred embodiment of the present invention, latent indexes, materialized query tables or other auxiliary database structures generated for the purpose of executing a query are saved for possible re-use as part of plan cache 209. If another instance of the same or a different query subsequently executes, which would otherwise generate the same latent auxiliary data structure for its use, a determination is made whether to update the previously generated and saved latent auxiliary database structure as an alternative to generating a new one. This decision will depend on various factors, but generally it depends on the volume of intervening change activity. If the cost of updating the previously generated latent structure is projected to be less than that of generating a new structure, the previously generated structure is updated for use in the new query instance.

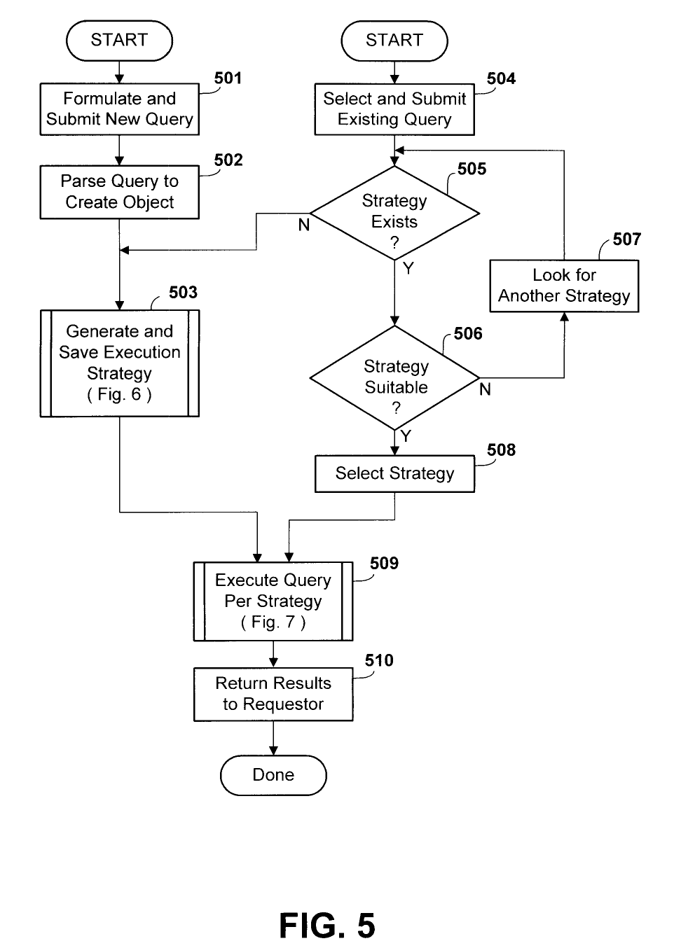

FIG. 5 is a flow diagram illustrating at a high level the process of executing a database query, according to the preferred embodiment. Referring to FIG. 5, a query may be initiated either as a newly defined query, or as a re-used (previously executed and saved) query, as shown by the two paths beginning at blocks 501 and 506, respectively.

For a new query, a requesting user formulates and submits a database query using any of various techniques now known or hereafter developed (step 501). E.g., the database query might be constructed and submitted interactively using a query interface in database management system 214, might be submitted from a separate interactive query application program, or might be embedded in a user application and submitted by a call to the query engine 216 when the user application is executed. A query might be submitted from an application executing on system 100, or might be submitted from a remote application executing on a different computer system. In response to receiving the query, the system parses the query into logical conditions to generate a query object (step 502), which may be saved for re-use.

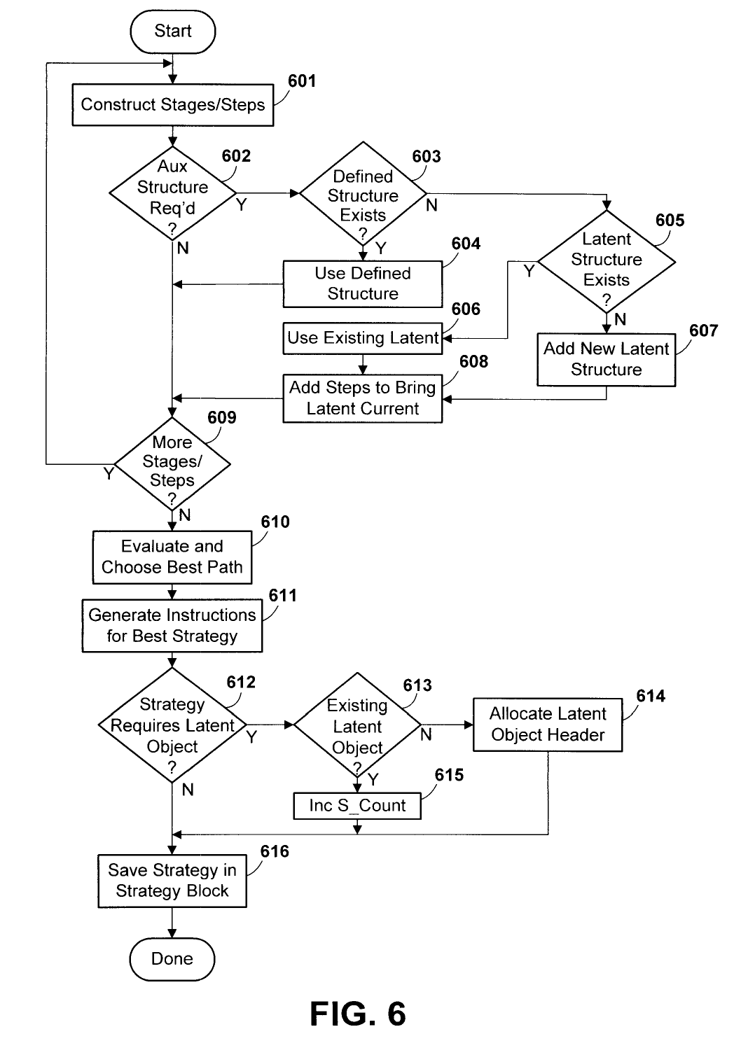

The system invokes optimizer 215 to generate an optimized execution strategy block for the query. Optimizer 215 determines an optimum execution strategy for the given query using any conventional technique or any technique hereafter developed, and may take into account imported variable values, environmental parameters, or other data. In particular, in at least some cases optimizer 215 may determine that, during execution a latent auxiliary database structure, such as index 212 or materialized query table 213, should be constructed as an intermediate step in executing the query. The process of generating an execution strategy is represented in FIG. 5 as step 503, and shown in greater detail in FIG. 6. After generation and saving of a suitable execution strategy at step 503, the database management system proceeds to step 509.

Where an existing query is re-used, a requesting user selects the existing query object for re-use and invokes it, using any of various techniques now known or hereafter developed (step 504). E.g., the query might be selected interactively from a menu in database management system 214, might be submitted from a separate interactive application program, or might be embedded in a user application and submitted by a call to the query engine 216 when the user application is executed, any of which might be performed from system 100, or from a remote system. Re-using an existing query may require specifying one or more imported variable values or other conditions of execution

In response to invoking the query, query optimizer 215 determines whether a saved strategy exists in the query object 210 (step 505). If no such strategy exists (the ‘N’ branch from step 505), the optimizer generates one (step 503), as in the case of a new query. If a previously saved execution strategy exists for the query (the ‘Y’ branch from step 505), the optimizer determines whether the saved execution strategy is suitable for use under the execution parameters of the current query instance (step 506). This determination may be made using any appropriate technique, now known or hereafter developed, but in general the optimizer accesses certain data in header 314 associated with the query execution strategy, which were saved when the strategy was initially generated, to determine whether the existing strategy can be re-used for the current execution parameters (e.g., imported variable values, system configuration, database configuration etc. If the saved execution strategy is not suitable for use in the current query instance, then the ‘N’ branch is taken from step 506, and the database management system looks for another previously saved execution strategy (step 507), continuing then to step 505. The database management system continues to look for execution strategies (loop at steps 505-507) until a suitable strategy is found (the ‘Y’ branch from step 506) or there are no more strategies (the ‘N’ branch from step 505).

If a suitable execution strategy is found, the ‘Y’ branch is taken from step 506, and the execution strategy is selected (step 508). Where multiple execution strategies are permissible (multiple strategies satisfy their respective logical conditions), the database manager will choose one of these multiple strategies. Such a choice could be based on priorities, or any criteria or technique now known or hereafter developed, or could be arbitrary. After selecting a strategy, the database management system proceeds to step 509.

The query engine is then invoked to execute the query according to the query execution strategy which was either generated at step 503 or selected at step 508. Generally, this means that the query engine retrieves selective database records according to the query execution strategy, and evaluates the logical query conditions with respect to the selected record in an order determined by the strategy. E.g., for a conjunction of logical ANDs, each successive condition is evaluated until a condition returns “false” (which obviates the need to evaluate any further conditions) or until all conditions are evaluated. In particular, the query engine may use a latent auxiliary database structure if the chose execution strategy so requires. Execution is represented in FIG. 5 as step 509, and shown in greater detail in FIG. 7.

The query engine then generates and returns results in an appropriate form (step 510). E.g., where a user issues an interactive query, this typically means returning a list of matching database entries for display to the user. A query from an application program may perform some other function with respect to database entries matching a query.

FIG. 6 is a flow diagram showing the in greater detail the process of generating and saving an execution strategy, which is represented in FIG. 5 as step 503, according to the preferred embodiment. Referring to FIG. 6, in general a query optimizer constructs stages or steps for executing a query (step 601), which may represent simple steps of a primitive form or aggregations of steps as intermediate stages to executing a query. These may be constructed using any known technique for constructing execution steps in a query or any technique hereafter developed.

At some point, some stage or steps(s) may require the use of an auxiliary data structure such as an index, represented as the ‘Y’ branch from step 602. If a defined auxiliary data structure of the required type exists (i.e., one which is part of the database specification, and which is regularly maintained by the database management system 214), the ‘Y’ branch is taken from step 603 the defined auxiliary structure is used for implementing the stage or step(s) of query execution (step 604). If no such defined auxiliary structure exists, the ‘N’ branch is taken from step 603. In this case, if a latent auxiliary database structure of the required type already exists (i.e., one which was previously created as a result of executing another execution strategy, either for the same query or a different query), then the ‘Y’ branch is taken from step 605, and the existing latent auxiliary database structure is used for implementing the stage or step(s) of query execution (step 606). If neither a defined structure nor a latent structure of the required type already exists, the ‘N’ branch is taken from step 605, and a new latent auxiliary database structure of the required type is tentatively created (or assumed) for purposes of implementing the state or step(s) of query execution (step 607). In the case of either using an existing latent structure (step 606) or creating a new latent structure (step 607), additional steps are added to the stage or step(s) of query execution to assure that the latent structure is current (step 608). I.e., unlike the case of a defined auxiliary structure, which is maintained automatically by the database management system, a latent structure is not automatically maintained, and generally will not be current. In order to assure that the latent structure is current at the time of query execution, it will either have to be updated using the change logs or rebuilt at execution time.

The query optimizer may then return to step 601 to construct more stages or steps (the ‘Y’ branch from step 609). The optimizer may construct additional stages or steps to perform some different part of the query execution task, or may construct additional stages or steps as alternatives to stages or steps already constructed. When finished constructing stages or steps of execution, the ‘N’ branch is taken from step 609. The optimizer may thus use an arbitrary number of defined and/or latent database structures for executing any given query.

At some point, the optimizer will evaluate different stages or steps, and choose a best path (i.e., sequence of stages or steps) for executing the query (step 610). Evaluation and choice of path is performed by conventional optimizers, and any conventional technique, or any technique developed in the future, may be used for choosing a best path. In evaluating a best path, the optimizer will generally consider the cost of updating a latent auxiliary database structure. I.e., it may choose to use an alternative strategy which does not require the latent auxiliary structure because the projected cost of updating the structure outweighs the benefits of its use. The “cost”, as used herein, could be any appropriate measure of resource cost, and may take into account factors such as CPU utilization, storage or other I/O operations, response time, or other measures of “cost”.

In evaluating cost using conventional optimization techniques, the cost of any path requiring a latent auxiliary structure will include the cost of building the latent auxiliary structure from scratch, because it is assumed that such a structure is for one-time use only with each query execution instance, and will be deleted after the query executes. I.e., the cost of Plan PL (CostPL) which uses latent auxiliary object L can be generally expressed as:
CostPL=Cost_Exec_{—}L+Cost_Build_{—}L (1)
where Cost_Build_L is the cost of building latent auxiliary object L and Cost_Exec_L is the cost of executing plan PL using latent auxiliary object L, once it is available. It is possible to use such an evaluation technique in accordance with the preferred embodiment of the present invention. However, this must be viewed as a worst-case cost measure, because it is hoped that in at least some cases latent auxiliary database structure L will be re-used. Therefore it may alternatively be possible to amortize the cost of building the latent auxiliary structure over multiple projected execution instances of the query. Such as cost evaluation technique can be generally expressed as:
CostPL=Cost_Exec_{—}L+(Cost_Build_{—}L+Cost_Update_{—}L)/#Exec (2)
where #Exec is the number of projected execution instances and Cost_Update_L is the projected cost of updating auxiliary object L over the projected execution instances. Although equation (2) is theoretically more accurate, it may be difficult to obtain accurate projections of the number of execution instances, and inaccurate projections could lead to unnecessary creation and proliferation of latent auxiliary objects. Projections could be obtained by recording the number of execution instances in a sample time interval, and periodically re-evaluating query plans to determine whether the frequency of execution justifies construction of a latent auxiliary object.

Once a best path sequence has been chosen from the multiple possibilities, the optimizer generates a set of execution strategy instructions for implementing the best path sequence of stages or steps (step 611); these execution strategy instructions are used by the query engine 216 when executing the query.

If the execution strategy thus chosen and constructed requires the use of a latent auxiliary database structure object (the ‘Y’ branch from step 612), then, with respect to each such latent structure, if the latent object already exists (the ‘Y’ branch from step 613), the strategy reference count 403, 413 in the latent objects's header 401, 411 is incremented by one to reflect that one more strategy uses the corresponding latent object (step 615); and if the latent object does not already exist (the ‘N’ branch from step 613), a corresponding latent object of minimal size, generally including only a header or portion of a header, is allocated, the strategy reference count being initialized to one (step 614).

The set of execution strategy instructions generated at step 611 are saved as a new strategy block 302, 303 in the query object, along with any required header information (step 616). If any latent objects are used by the strategy, appropriate references 316, 317 to the latent objects are inserted into the strategy block header 314, 315.

FIG. 7 is a flow diagram showing the in greater detail the process of executing a query according to a generated or selected execution strategy, which is represented in FIG. 5 as step 509, according to the preferred embodiment. The query engine executes the query by successively executing or performing instructions contained in the execution strategy. In the preferred embodiment, these are not instructions directly executable by a processor, but are instructions to the query engine, each of which is successively interpreted by the query engine to perform some action or set of actions. For purposes of the high-level flow diagram of FIG. 7, instructions which involve access to a latent auxiliary database object are shown in greater detail than all other instructions.

Referring to FIG. 7, if a next instruction does not require access to a latent object (the ‘N’ branch from step 701), the instruction is executed by the query engine in the conventional manner (step 702). If there are more instructions to execute (the ‘Y’ branch from step 709), the query engine returns to step 701 to process the next instruction. When all instructions have been processed, the ‘N’ branch is taken from step 709 and query execution is complete.

If, at step 701, the instruction requires access to a latent object, the ‘Y’ branch is taken from step 701, and the corresponding latent object is accessed to determine the time at which it was last updated to a current state (step 703). Appropriate database change logs or other structures are then accessed estimate a cost of updating the latent object from changes recorded in the change log and a cost of rebuilding the latent object from scratch (step 704). I.e., the existing latent object, which is typically not current because it is not regularly maintained, can be updated to a current state in which it accurately reflects the current contents of the database tables by accessing one or more change logs which records changes to the database table contents, and processing each change occurring after the latent object was last updated to modify the latent object accordingly. Alternatively, the existing latent object can be simply discarded, and a new latent object rebuilt from scratch by examining the current database table or tables. Where the latent object was last updated relatively recently and the number of database changes since update is not large, it will generally be less costly to update the existing latent object from the change logs. As the length of time since update and the number of changes increases, the cost of updating the existing latent object from the change logs increases correspondingly. At some point, the changes will be so numerous that it will be less costly to reconstruct the latent object from scratch using the current database tables, without reference to the change logs. Various conventional techniques exist for estimating a resource “cost” associated with updating an auxiliary database structure from a change log as well as for rebuilding an auxiliary database structure from scratch, and any of these techniques, or any technique hereafter developed, could be used.

If the projected cost of rebuilding is less than the projected cost of updating from the change logs (the ‘Y’ branch from step 705), the latent object is rebuilt from scratch using the current database table or tables, the rebuilt object replacing the existing latent object (step 706). If the projected cost of rebuilding is not less than the projected cost of updating from the logs (the ‘N’ branch from step 705), the change entries in the change log(s) are accessed and the existing latent object is updated to conform to the change entries in the change logs, bringing it to a current state (step 707). In either case, the rebuilt or updated latent object is returned for use in executing the query (step 708).

Steps 703-708 could be implemented in either the optimizer or the query engine. I.e., steps 703-708 could be performed by the query engine responsive to explicit instructions contained in the execution strategy which are placed there by the optimizer, in which case the query engine might not itself require any modification to implement the present invention according to its preferred embodiment. Alternatively, the query engine could interpret an instruction in an execution strategy requiring access to a latent object to require that the latent object be brought current as explained above; in this alternative, the optimizer would simply insert an instruction to access the latent object, and the query engine would be responsible for interpreting the instruction to require appropriate updating or rebuilding of the object as described.

The strategy reference count 403, 413 in the header of a latent auxiliary database structure (object) reflects the number of strategies which access that latent object. As explained above, each time a new strategy is created which accesses the latent object, the strategy reference count is incremented. By the same token, if a strategy is deleted for any reason, the corresponding strategy reference count of any latent object accessed by the deleted strategy is decremented by one. Strategies may be deleted for any of various reasons, e.g., a strategy may be superseded by a new strategy constructed by the optimizer; a query for which the strategy was constructed might be explicitly deleted by a user; etc. If a latent object's strategy reference count is decremented to zero, then it is known that no more strategies use that latent object. In this case, the latent object itself will be automatically deleted by the database manager.

Among the advantages of the technique described herein as a preferred embodiment is that no additional burden is assumed in maintaining various latent auxiliary database structures, unless some cost benefit can be projected therefrom. A projected cost analysis, based on actual number of changes in the change logs and size of the database tables, should be reasonably accurate. Only if there is a cost savings will a latent object be updated; in all other cases, the latent object will be rebuilt as in conventional art.

In the preferred embodiment described above, the generation and execution of the query, and the use of latent auxiliary database objects, is described as a series of steps in a particular order. However, it will be recognized by those skilled in the art that the order of performing certain steps may vary, and that variations in addition to those specifically mentioned above exist in the way particular steps might be performed. In particular, the manner in which queries are written, parsed or compiled, and stored, may vary depending on the database environment and other factors.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, volatile and non-volatile memory devices, floppy disks, hard-disk drives, CD-ROM's, DVD's, magnetic tape, and so forth. Furthermore, the invention applies to any form of signal-bearing media regardless of whether data is exchanged from one form of signal-bearing media to another over a transmission network, including a wireless network. Examples of signal-bearing media are illustrated in FIG. 1 as system memory 102, and as data storage devices 125-127.

Although a specific embodiment of the invention has been disclosed along with certain alternatives, it will be recognized by those skilled in the art that additional variations in form and detail may be made within the scope of the following claims:

What is claimed is:

1. A method for executing database queries against data in a database in at least one computer system, comprising the computer-executed steps of:
executing a first query instance against data in said database of said at least one computer system;
generating a latent auxiliary database structure from data in one or more tables of said database for use in executing said first query instance, said latent auxiliary database structure being an auxiliary database structure which is not defined in a specification of said database and not concurrently maintained as changes are made to said database;
saving said latent auxiliary database structure after execution of said first query instance;
executing a second query instance against data in said database, said second query instance being executed after execution of said first query instance, wherein execution of said second query instance requires access to a version of said latent auxiliary database structure which is current as of the time of execution of said second query instance; and
updating said latent auxiliary database structure to a current state for use in executing said second query instance.

2. The method for executing database queries of claim 1, wherein said latent auxiliary database structure is an index.

3. The method for executing database queries of claim 1, wherein said latent auxiliary database structure is a materialized query table.

4. The method for executing database queries of claim 1, further comprising the steps of:
projecting whether a cost of updating said latent auxiliary database structure to a current state for use in executing said second query instance exceeds a cost of regenerating said latent auxiliary database structure from data in one or more tables of said database for use in executing said second query instance;
responsive to projecting that said cost of updating said latent auxiliary database structure to a current state for use in executing said second query instance exceeds said cost of regenerating said latent auxiliary database structure from data in one or more tables of said database for use in executing said second query instance, regenerating said latent auxiliary database structure from data in one or more tables of said database for use in executing said second query instance; and
responsive to projecting that said cost of updating said latent auxiliary database structure to a current state for use in executing said second query instance is less than said cost of regenerating said latent auxiliary database structure from data in one or more tables of said database for use in executing said second query instance, performing said step of updating said latent auxiliary database structure to a current state for use in executing said second query instance.

5. The method for executing database queries of claim 1, wherein said first query instance and said second query instance are different respective instances of the same query.

6. The method for executing database queries of claim 1, wherein said first query instance and said second query instance are different respective instances of different queries.

7. The method for executing database queries of claim 1, further comprising the steps of:
saving a plurality of query execution strategies for later re-use;
maintaining a strategy reference count associated with said latent auxiliary database structure, said strategy reference count recording a number of said query execution strategies which reference said latent auxiliary database structure during execution; and
deleting said latent auxiliary database structure if said strategy reference count drops to zero.

8. A computer program product for executing database queries against a database in at least one computer system, comprising:
a plurality of computer-executable instructions recorded on signal-bearing media, wherein said instructions, when executed by at least one computer system, cause the at least one computer system to perform the steps of:
executing a first query instance against data in said database of said at least one computer system;
generating a latent auxiliary database structure from data in one or more tables of said database for use in executing said first query instance, said latent auxiliary database structure being an auxiliary database structure which is not defined in a specification of said database and not concurrently maintained as changes are made to said database;
saving said latent auxiliary database structure after execution of said first query instance;
executing a second query instance against data in said database, said second query instance being executed after execution of said first query instance, wherein execution of said second query instance requires access to a version of said latent auxiliary database structure which is current as of the time of execution of said second query instance; and
updating said latent auxiliary database structure to a current state for use in executing said second query instance.

9. The computer program product of claim 8, wherein said latent auxiliary database structure is an index.

10. The computer program product of claim 8, wherein said latent auxiliary database structure is a materialized query table.

11. The computer program product of claim 8, wherein said instructions further cause the at least one computer system to perform the steps of:
projecting whether a cost of updating said latent auxiliary database structure to a current state for use in executing said second query instance exceeds a cost of regenerating said latent auxiliary database structure from data in one or more tables of said database for use in executing said second query instance;
responsive to projecting that said cost of updating said latent auxiliary database structure to a current state for use in executing said second query instance exceeds said cost of regenerating said latent auxiliary database structure from data in one or more tables of said database for use in executing said second query instance, regenerating said latent auxiliary database structure from data in one or more tables of said database for use in executing said second query instance; and
responsive to projecting that said cost of updating said latent auxiliary database structure to a current state for use in executing said second query instance is less than said cost of regenerating said latent auxiliary database structure from data in one or more tables of said database for use in executing said second query instance, performing said step of updating said latent auxiliary database structure to a current state for use in executing said second query instance.

12. The computer program product of claim 8, wherein said first query instance and said second query instance are different respective instances of the same query.

13. The computer program product of claim 8, wherein said first query instance and said second query instance are different respective instances of different queries.

14. The computer program product of claim 8, wherein said instructions further cause the at least one computer system to perform the steps of:
saving a plurality of query execution strategies for later re-use;
maintaining a strategy reference count associated with said latent auxiliary database structure, said strategy reference count recording a number of said query execution strategies which reference said latent auxiliary database structure during execution; and
deleting said latent auxiliary database structure if said strategy reference count drops to zero.

15. A computer system, comprising:
at least one processor;
a data storage for storing a database, said database containing at least one database table;
a database management facility embodied as a plurality of instructions executable on said at least one processor, said database management facility executing logical queries against data in said database,
wherein said database management facility generates latent auxiliary database structures from data in said at least one database table for use in executing said logical queries, each said latent auxiliary database structure being an auxiliary database structure which is not defined in a specification of said database and not concurrently maintained as changes are made to said database; and
wherein said database management facility saves said latent auxiliary database structures generated for executing respective instances of respective database queries for use in executing subsequent respective instances of respective database queries; and
wherein said database management facility automatically updates said latent auxiliary database structures to respective current states for use in executing said subsequent respective instances of respective database queries.

16. The computer system of claim 15, wherein said latent auxiliary database structure is an index.

17. The computer system of claim 15, wherein said latent auxiliary database structure is a materialized query table.

18. The computer system of claim 15, wherein said database management system further projects whether a respective cost of updating said latent auxiliary database structure to a respective current state for use in executing said subsequent instances of respective database queries a respective cost of regenerating said latent auxiliary database structure from data in one or more tables of said database for use in executing subsequent query instances, and automatically updates said latent auxiliary database structure to a respective current state only if the projected respective cost of updating is less than the respective cost of regenerating said latent auxiliary database structure from data in one or more tables of said database.

19. The computer system of claim 15, wherein said database management system further maintains a strategy reference count associated with said latent auxiliary database structure, said strategy reference count recording a number of saved query execution strategies which reference said latent auxiliary database structure during execution, said database management system causing said latent auxiliary database structure to be deleted if said strategy reference count drops to zero.
